(19) United States
(12) Patent Application Publication
(10) Pub. No.: US 2026/0151977 A1
(43) Pub. Date: Jun. 4, 2026

(54) SEPARATOR DEVICE FOR DEWATERING WET MATTER

(71) Applicant: VOGELSANG GMBH & CO. KG, Essen (DE)

(72) Inventors: Paul Krampe, Essen (DE); Torsten Burhorst, Essen (DE); Lukas Hoffmann, Essen (DE)

(73) Assignee: VOGELSANG GMBH & CO. KG, Essen (DE)

(21) Appl. No.: 18/704,576

(22) PCT Filed: Oct. 24, 2022
(86) PCT No.: PCT/EP2022/079549

§ 371 Date: Apr. 25, 2024

(30) Foreign Application Priority Data
Oct. 28, 2021 (DE) 10 2021 128 199.7

(51) Int. Cl. B30B 9/12

(52) U.S. Cl. CPC B30B 9/121

(57) ABSTRACT

A separator device for separating liquid from solids of matter includes a drive shaft rotatable about a drive axis of rotation and extending in an axial direction between an upstream shaft end and a downstream shaft end. A screw conveyor connected to the drive shaft is adapted to convey the matter in a conveying direction from an upstream inlet to an outlet downstream from the inlet. The screw conveyor at least partially encloses the drive shaft and a screening device encloses the screw conveyor. The screening device is adapted to separate liquid from the solids of the matter and to convey the matter in the conveying direction. A drive unit is coupled to the downstream shaft end of the drive shaft. The drive shaft is mechanically coupled to the drive unit such that the drive shaft is in the for of a tension rod.

### CROSS-REFERENCE TO FOREIGN PRIORITY APPLICATION

The present application claims the benefit under 35 U.S.C. §§ 119(b), 119(e), 120, and/or 365(c) of International Application No. PCT/EP2022/079549 filed Oct. 24, 2022, which claims priority to German Application No. DE 10 2021 128 199.7 filed Oct. 28, 2021.

### FIELD OF THE INVENTION

The invention relates to a separator device for dewatering a wet mass, the separator device having a drive shaft which is mounted rotatably about a drive rotational axis and extends in an axial direction between an upstream shaft end and a downstream shaft end, a conveying screw which is connected to the drive shaft and is configured to convey the mass in a conveying direction from an upstream inlet to an outlet which lies downstream with respect to the inlet, a screen device which encloses the conveying screw, the screen device being configured to separate liquid from solids of the mass, and to guide the mass, in particular solids of the mass, in the conveying direction from the inlet to the outlet, and a drive unit which, in order to drive the drive shaft, is coupled to the drive shaft, in particular to the downstream shaft end of the drive shaft.

### BACKGROUND OF THE INVENTION

It is known for a wet mass to be dewatered by way of a separator device. In order to dewater wet masses, separator devices of this type have a cylindrical conveying screw which is enclosed by a screen device. The conveying screw is driven by way of a drive unit. In order to achieve an optimum dewatering result, the conveying screw has to bear as tightly as possible against the screen device. This requires high manufacturing accuracies during the production of the conveying screw and the screen device. In order that the conveying screw does not jam with the screen device and correspondingly bears tightly against the screen device, the conveying screw is to be centered within the screen device with high accuracy. In this regard, the manufacture of the screen device and the conveying screw and the assembly of the separator device are complicated and expensive.

It is therefore an object to provide a separator device for dewatering wet masses, which separator device makes simple and inexpensive dewatering of wet masses possible.

### SUMMARY OF THE INVENTION

In accordance with a first aspect, this object is achieved by way of a separator device as disclosed herein. The separator device is configured to dewater wet masses. A wet mass is, in particular, a solids-containing suspension. A wet mass comprises, in particular, solids and liquid.

In order to dewater the wet mass, the separator device has a drive shaft which is mounted rotatably about a drive rotational axis. The drive shaft extends in an axial direction between an upstream shaft end and a downstream shaft end. The drive rotational axis extends substantially along the axial direction.

Furthermore, the separator device has a conveying screw. The conveying screw is connected to the drive shaft. In particular, the conveying screw encloses the drive shaft at least partially. The drive shaft preferably extends through the conveying screw.

The conveying screw is configured to convey the mass to be dewatered in a conveying direction from an upstream inlet to an outlet which is downstream with respect to the inlet. In the conveying direction, the mass to be dewatered is increasingly dewatered, that is to say liquid is separated from the mass to be dewatered, with the result that the dry mass content of the mass to be dewatered increases from the inlet to the outlet. The dry mass content of the mass to be dewatered is therefore greater at the outlet than at the inlet. The degree of dewatering is dependent substantially on the conveying pressure which the conveying screw generates. The higher the conveying pressure, the higher the dry mass content of the mass to be dewatered at the outlet. The dry mass content is, in particular, the ratio of mass of the dry substance in relation to the total mass which comprises the mass of the dry substance and the mass of the liquid.

The conveying screw is preferably of conical or cylindrical configuration. In particular, it is preferred that the conveying screw has a screw cross-sectional area which decreases from the upstream inlet to the downstream outlet or is constant. In particular, the conveying screw has a screw flight, in particular a conical screw flight, with a screw flight height which varies in the conveying direction or is constant. The screw flight height preferably decreases from the upstream inlet to the downstream outlet.

It is preferably provided that the screw flight has a screw flight outer radius and a screw flight inner radius which is smaller than the screw flight outer radius, the screw flight outer radius decreasing in the conveying direction and the screw flight inner radius being constant, or the screw flight outer radius decreasing in the conveying direction and the screw flight inner radius decreasing, or the screw flight outer radius and the screw flight inner radius being constant in the conveying direction.

Furthermore, it is provided that the separator device has a screen device which encloses the conveying screw. The conveying screw preferably extends within the screen device. The conveying screw, in particular the screw flight, preferably bears tightly against the screen device, in particular the screen inner surface. The conveying screw is preferably arranged rotatably within the screen device. The screen device is preferably arranged in a stationary manner with respect to the conveying screw. It can be preferred that the screen device is mounted in a floating manner. A screen device which is mounted in a floating manner can move in the radial direction, for example on guide rails, but is arranged non-displaceably in the axial direction. The screen device is preferably double mounted.

The screen device is configured to separate the liquid from the wet mass, that is to say to dewater the latter. Furthermore, the screen device is configured to guide the wet mass, in particular solids of the wet mass, in the conveying direction from the inlet to the outlet.

The screen device of the separator device is preferably of conical, frustoconical, in particular hollow-conical configuration. The screen device comprises, in particular, a screen wall made from a curved or rolled metal sheet or a curved or rolled steel plate, into which outlet openings have been made as a screen pattern. The outlet openings are made, for example, by means of laser cutting. In particular, the screen wall is a conically or cylindrically rolled and/or conically or cylindrically curved screen wall. In particular, the screen wall has a welded seam which fixes the conically or cylindrically rolled and/or conically or cylindrically curved screen wall in a conical or cylindrical shape.

It is particularly preferred that, in order to separate the liquid from the wet mass, the screen device has a liquid-permeable screen wall of conical configuration with outlet openings which extend between a screen inner surface of the screen wall which faces the conveying screw and a screen outer surface of the screen wall, which screen outer surface lies radially on the outside in relation to the screen inner surface and faces away from the conveying screw. As a result, the liquid which is separated from the wet mass by way of the conveying pressure can exit from the screen device during the operation of the separator device.

In particular, the screen device has an annular screen cross-sectional area and/or a screen internal diameter and/or a screen external diameter which decrease/decreases from the upstream inlet to the downstream outlet or are/is constant between the upstream inlet and the downstream outlet.

The separator device preferably has a separator device housing, an inlet chamber, and/or an outlet chamber.

It is preferred that the screen device is arranged within the screen device housing. It is preferably provided in this preferred embodiment that the screen device housing has the inlet and the outlet, and the screen device is arranged within the screen device housing in such a way that the screen device connects the inlet and the outlet in flow terms. Furthermore, the screen device housing preferably has an outflow opening, through which the separated liquid can be discharged from the screen device housing.

It can be preferred that the separator device has a suction device which is connected to the outflow opening in flow terms. To this end, the suction device is preferably arranged outside the screen device and is connected to the screen device in flow terms downstream of the inlet. The suction device is configured to separate the liquid from the wet mass. The suction device sucks the liquid through the outlet openings of the liquid-permeable screen wall. For example, the suction device can be connected in flow terms to a liquid tank, into which the liquid is extracted.

Furthermore, a desired suction pressure can be set in the screen device by means of the suction device, by way of which suction pressure the liquid is sucked out of the screen device. In particular, the desired suction pressure can be set by means of the suction device in a manner which is dependent on a dry mass content desired at the outlet and/or the moisture of the wet mass to be dewatered which is provided at the inlet and/or the viscosity of the wet mass to be dewatered which is provided at the inlet. If, for example, a high dry mass content of the mass is desired at the outlet or the wet mass which is provided at the inlet is particularly wet, the suction pressure can be set to be correspondingly higher.

This preferred embodiment of the separator device is based on the finding of the inventors that no feed pump is required which has to feed the wet mass to be dewatered to the screen device. No feed pump is therefore required which has to be configured to feed both liquid and solids to the screen device. Since merely the liquid which is separated from the wet mass to be dewatered is extracted in the radial direction by way of the screen device, the suction device advantageously has to be configured merely to extract and possibly to convey liquid. The suction device is therefore subjected to substantially less wear in comparison with the feed pumps of the known systems.

Furthermore, it is finally provided in accordance with one preferred development of the separator device that the suction device is configured to suck in the liquid which is separated from the wet mass and/or the wet mass which is to be provided at the inlet by way of a vacuum. The vacuum is, in particular, a pressure which is lower than atmospheric pressure which prevails, in particular, at the operating location of the separator device. It is provided, in particular, that the suction device extracts the liquid by way of a pressure which is lower than the pressure which prevails at the inlet and/or outlet. In particular, the suction device is configured to generate a vacuum of such a type that the wet mass to be provided at the inlet can even be provided from a pit or the like which lies at a substantially lower location than the separator device.

In this regard, a separator device which is configured in this way has the advantage that the wet mass which is provided at the inlet is sucked in particularly satisfactorily. Furthermore, this development has the advantage that the wet mass can be sucked in even from pits which lie at a lower location than the separator device.

It is preferably provided that the inlet chamber is arranged at the inlet, the inlet chamber being configured to receive the wet mass to be dewatered and to provide it at the inlet. In addition or as an alternative, it is provided that the outlet chamber is arranged at the outlet, the outlet chamber being configured to receive the mass which is provided at the outlet and is separated from the liquid. The mass which is provided in the inlet chamber at the inlet has a higher moisture than the mass which is provided in the outlet chamber at the outlet.

In particular, it can be preferred that the separator device has a molding device which is arranged downstream of the outlet and which encloses the drive shaft. In particular, the molding device is arranged displaceably in the axial direction. The molding device is particularly preferably arranged displaceably in the axial direction with respect to the outlet. In particular, the molding device has a variable internal diameter which can be varied between a minimum internal diameter and a maximum internal diameter which is greater than the minimum internal diameter. The minimum internal diameter preferably corresponds to an external diameter of the conveying screw shaft. The molding device can be varied, in particular, between a closure position, in which the outlet is closed, and an open position, in which the outlet is open. In the closure position, the minimum internal diameter corresponds to the external diameter the minimum internal diameter to an external diameter of the conveying screw shaft and, in the open position, the internal diameter of the molding device is greater than the minimum internal diameter.

The molding device preferably has a ring unit. The ring unit can be configured as an elastic single-part ring, in particular as a single-part rubber ring. Furthermore, it can be preferred that the molding device has a molding device flange, to which the ring unit is fastened. In particular, the molding device flange has a cylindrical molding device flange portion. Furthermore, it can be preferred that the outlet is configured as a flange, it being possible for the outlet which is configured as a flange to have a cylindrical outlet portion. In particular, it is preferred that the cylindrical molding device flange portion is mounted movably on the cylindrical outlet portion.

The separator device preferably has a molding device adjusting unit which is configured to displace the molding device in the axial direction with respect to the screen device. The position of the molding device in the axial direction with respect to the screen device is preferably fixed once by way of displacement of the molding device. In particular, the separator device is configured to displace the molding device in the axial direction with respect to the screen device during the operation. In particular, the molding device adjusting unit is configured to displace the molding device with respect to the screen device in the axial direction during the operation of the separator device. The molding device can preferably be displaced with respect to the screen device in the axial direction in a manner which is dependent on the desired degree of dry mass content of the dewatered mass at the outlet and/or the moisture of the wet mass to be dewatered at the inlet and/or the viscosity of the wet mass to be dewatered at the inlet.

Furthermore, a desired conveying pressure can be set in the screen device by means of the molding device, by way of which conveying pressure the liquid is conveyed through the screen device. In particular, the desired conveying pressure can be shifted in the axial direction by means of the molding device in a manner which is dependent on a dry mass content which is desired at the outlet and/or the moisture of the wet mass to be dewatered which is provided at the inlet and/or the viscosity of the wet mass to be dewatered which is provided at the inlet. If, for example, a high dry mass content of the mass at the outlet is desired or the wet mass which is provided at the inlet is particularly wet, the molding device can be arranged at a correspondingly greater spacing from the outlet.

The invention is based on the finding that known solutions have solid flaps which close the outlet by means of a complex and space-occupying mechanism, comprising a drive unit, levers and possibly weights, and opens it at a certain conveying pressure. In the view of the inventors, customary solutions of this type are maintenance-intensive in comparison with the molding device according to the invention. On account of the space-saving configuration of the molding device according to the invention and the smaller maintenance intervals, an arrangement of the drive unit on the side of the outlet is advantageous according to the invention; in particular also since a dewatered wet mass exits on the outlet side, with the result that the drive unit does not have to be sealed separately with respect to a possible entry of liquid as is the case in the known solutions, in which the drive unit is arranged on the inlet side. The separator device according to the invention is therefore also less maintenance-intensive and less expensive than known solutions in this regard.

Furthermore, the separator device comprises a drive unit which, in order to drive the drive shaft, is coupled, in particular is coupled mechanically, to the downstream shaft end of the drive shaft. In particular, the drive unit is coupled mechanically without a seal to the drive shaft in the region of the downstream shaft end. In the present case, “without a seal” means, in particular, that no seal is present which is configured to prevent an entry of liquid into the drive unit. It can be provided, however, that a seal is arranged on the drive unit, which seal prevents the exit of lubricants and the like from the drive unit. It is provided that the drive shaft is coupled to the drive unit in such a way that the drive shaft is configured as a tension rod.

A separator device of this type has various advantages. As a result of the drive shaft which is configured as a tension rod, the drive shaft can be of thin configuration in comparison with known solutions. In particular, the drive shaft which is configured as a tension rod can be of flexurally slack configuration. In particular, as a result of the configuration of the drive shaft as a tension rod, the requirements of the tolerances are considerably lower. This is because the drive shaft which is configured as a tension rod readily compensates for manufacturing-induced and/or assembly-induced angular errors.

In particular, the invention is based on the finding that the conveying screw bears tightly against the screen device even in the case of substantially lower manufacturing accuracies in comparison with known solutions. Furthermore, the invention is based on the finding that the arrangement of the drive shaft as a tension rod makes automatic centering of the conveying screw with respect to the screen device possible.

The embodiment according to the invention of the separator device makes the arrangement of the drive unit on the side of the outlet possible. As a result, the necessity for a seal which is configured to prevent the entry of the liquid of the mass to be dewatered into the drive unit is dispensed with. Since seals of this type are subject to wear over time, the outlet-side arrangement of the drive unit leads to a substantially lower-wear separator device in comparison with the known solutions. Therefore, in the case of the separator device according to the invention, substantially less maintenance and servicing work arises in comparison with the known solutions. Furthermore, as a result of this outlet-side arrangement of the drive unit, the probability of failure of the separator device on account of the entry of liquid into the drive unit decreases considerably.

It is provided in accordance with one preferred embodiment of the separator device that the drive shaft is configured as a solid shaft and/or the conveying screw is of hollow configuration. It is provided, in particular, that the drive shaft extends within the conveying screw. The drive shaft preferably has an external diameter which is smaller than the internal diameter of the conveying screw which is configured as a hollow shaft. In particular, the drive shaft extends within the conveying screw spaced apart from the inner wall of the conveying screw. This has the advantage that the drive shaft with the conveying screw can compensate for even relatively large angular errors. Furthermore, this has the advantage that the drive shaft can be mounted more easily on the conveying screw, and merely the upstream shaft end of the drive shaft and the upstream conveying screw end are in contact with one another.

It is provided in accordance with a further preferred development of the separator device that the drive shaft is of flexurally slack configuration and the conveying screw is of flexurally stiff configuration in comparison with the drive shaft. It is provided, in particular, that the drive shaft has a lower geometrical moment of inertia in comparison with the conveying screw. Furthermore, it can be preferred in addition or as an alternative that the drive shaft has a lower flexural stiffness and/or a lower torsional stiffness in comparison with the conveying screw.

The comparatively flexurally stiff conveying screw of this preferred development of the separator device makes a particularly advantageous pressing action for dewatering the mass to be dewatered possible. In contrast, the comparatively flexurally slack drive shaft compensates for possible angular errors. This preferred embodiment particularly advantageously makes a production of the separator device in a less tight tolerance range possible, without the pressing action of the conveying screw being reduced as a result of a reduced conveying pressure on account of leakage.

It is provided in accordance with a further preferred embodiment of the separator device that the drive shaft is configured in multiple parts. In particular, the drive shaft which is configured in multiple parts has a first sub-shaft and a second sub-shaft. It is provided that the first sub-shaft is mounted rotatably and drivably in the drive unit. Furthermore, it is provided that the second sub-shaft is coupled to the conveying screw and is coupled at an upstream end to the conveying screw. The first sub-shaft and the second sub-shaft, and the second sub-shaft and the conveying screw, are preferably coupled to one another in a manner which is fixed in terms of torque and/or transmits an axial force.

The first sub-shaft and the second sub-shaft can be coupled to one another, for example, by way of a screw and plug-in connection. It is provided, in particular, that the first sub-shaft has, in the axial direction, a through bore, through which a screw is guided, and the second sub-shaft has, in the axial direction, a threaded bore, into which the screw is screwed. Furthermore, it can be preferred that the first sub-shaft has a shaft shoulder, and the second sub-shaft has a receiving portion, into which the shaft shoulder of the first sub-shaft can be received. It is provided, in particular, that the first shaft shoulder is displaceable in the axial direction within the receiving portion. The first and second sub-shafts are preferably connected to one another in the region of the outlet chamber.

The drive shaft which is configured in multiple parts facilitates the assembly and dismantling of the separator device for maintenance and servicing work. This effect is achieved, in particular, if the first sub-shaft and the second sub-shaft are connected to one another in the region of the outlet chamber.

Furthermore, it is provided in accordance with one preferred development of the separator device that the conveying screw extends in the axial direction between an upstream screw end and a downstream screw end, the conveying screw in the region of the upstream screw end being coupled mechanically to the drive shaft in the region of the upstream shaft end.

Furthermore, it is provided in one preferred embodiment of the separator device that the conveying screw and the drive shaft are coupled to one another in a non-positive and/or positively locking manner. It is provided, in particular, that the conveying screw and the drive shaft are coupled to one another in a non-positive manner by way of a screw connection and/or interference fit and/or feather key or the like.

Furthermore, it is provided in accordance with one preferred development of the separator device that the conveying screw and the drive shaft are coupled to one another in a manner which is fixed in terms of torque and/or transmits an axial force.

It is provided in accordance with a further preferred embodiment of the separator device that the drive shaft is configured as a tension rod which, in the region of the upstream shaft end and in the region of the downstream shaft end, in each case has a shaft end portion with a cross section, the area extent of which is greater than an area extent of a cross section of a shaft middle portion which extends between the two shaft end portions. A tension rod of this type which has a constriction has the advantage that it is firstly particularly flexurally slack, but has the required thickness for coupling to the drive unit and/or the conveying screw at the ends in order to transmit the torque from the drive unit to the conveying screw. In this preferred embodiment, the drive shaft can be produced particularly simply and is comparatively low-maintenance.

In addition or as an alternative, it is provided in this preferred embodiment that the drive shaft has at least one universal joint and/or is configured as a cardan shaft. This preferred embodiment advantageously makes a comparatively compact overall design of the drive shaft and therefore, if this is desired, also of the separator device possible. In this preferred embodiment, the universal joint or the cardan shaft makes the compensation of possible angular errors and the like possible.

It is provided in a further development of the separator device that the drive shaft in the region of the downstream shaft end and the drive unit are coupled to one another in a non-positive and/or positively locking manner. It is provided, in particular, that the drive shaft in the region of the downstream shaft end and the drive unit are coupled to one another in a non-positive manner by way of a screw connection and/or interference fit and/or feather key or the like.

Furthermore, it is provided in accordance with one preferred embodiment of the separator device that the drive shaft and the drive unit are coupled to one another in a manner which is fixed in terms of torque and/or transmits an axial force.

Furthermore, it is provided in a further preferred development of the separator device that the drive unit has a motor shaft which is mounted rotatably about a motor rotational axis, the drive unit being arranged in such a way that the motor rotational axis is inclined with respect to the drive rotational axis.

It is provided in accordance with one further preferred development of the separator device that the drive unit is arranged with respect to the drive shaft in such a way that the motor rotational axis extends orthogonally with respect to the drive rotational axis. An arrangement of this type of the drive unit makes a comparatively simple access in the axial direction to the separator device possible.

Furthermore, it is provided in accordance with one preferred development of the separator device that the outlet is arranged between the drive unit and the screen device.

It is provided in accordance with a further preferred embodiment of the separator device that the drive shaft and/or the conveying screw are/is arranged displaceably in the axial direction with respect to the screen device. In particular, the separator device has a shaft adjusting unit for adjusting the drive shaft and/or the conveying screw in the axial direction.

The position of the drive shaft and/or the conveying screw in the axial direction with respect to the screen device is preferably fixed once by way of displacement of the drive shaft and/or the conveying screw. In particular, the drive shaft and/or the conveying screw can be displaced in the axial direction with respect to the screen device by means of the shaft adjusting unit. In particular, the separator device is configured to displace the drive shaft and/or the conveying screw in the axial direction with respect to the screen device during operation. In particular, the shaft adjusting unit is configured to displace the drive shaft and/or the conveying screw in the axial direction with respect to the screen device during the operation of the separator device. The drive shaft and/or the conveying screw can preferably be displaced in the axial direction with respect to the screen device in a manner which is dependent on the desired degree of dry mass content of the dewatered mass at the outlet and/or the moisture of the wet mass to be dewatered at the inlet and/or the viscosity of the wet mass to be dewatered at the inlet.

### Second Aspect of the Invention: Conically Configured Screen Device and Conveying Screw

In accordance with a second aspect, the invention relates to a separator device for dewatering a wet mass.

Although known separator devices of this type can be produced inexpensively, the screw flights of the conveying screws are subject to wear during the operation of the separator device. During the wear, a gap arises between the conveying screw and the screen device. The resulting gap facilitates leakage in the conveying direction of the separator, with the result that the wet mass is conveyed with a lower pressure. As a consequence, the wet mass can be dewatered increasingly less satisfactorily as the operating duration of the separator device increases.

It is therefore required in the case of the known separator devices for the conveying screw to be replaced at regular intervals or else for the conveying screw to be overhauled by way of material application and by way of corresponding machining for further operation in the separator device, with the result that the conveying screw again bears tightly against the screen device. The replacement or the overhauling of the conveying screw is complex and expensive.

It is therefore an object to provide a separator device for dewatering wet masses, which separator device makes simple and inexpensive dewatering of wet masses possible.

In accordance with this second aspect, this object is achieved by way of a separator device for dewatering a wet mass, the separator device having a drive shaft which is mounted rotatably about a drive rotational axis and extends in an axial direction between an upstream shaft end and a downstream shaft end, a conveying screw which is connected to the drive shaft and is configured to convey the wet mass to be separated from the liquid in a conveying direction from an upstream inlet to an outlet which is downstream with respect to the inlet, a screen device which encloses the conveying screw, the screen device being configured to separate the liquid from the wet mass, and to guide the wet mass, in particular solids of the wet mass, in the conveying direction from the inlet to the outlet, and characterized in that the envelope of the conveying screw and the inner surface of the screen device are each of conical configuration.

As a result of the conical configuration of the contact surface between the conveying screw and the screen device, a play which occurs as a result of wear between the conveying screw and the screen device can be brought about simply by way of an axial adjustment. This axial adjustment takes place by way of relative movement between the conveying screw and the screen device along the longitudinal axis of the conveying screw; in particular, the conveying screw can be mounted axially displaceably.

The separator device is configured to dewater wet masses. A wet mass is, in particular, a solids-containing suspension. A wet mass comprises, in particular, solids and liquid.

In order to dewater the wet mass, the separator device has a drive shaft which is mounted rotatably about a drive rotational axis. The drive shaft extends in an axial direction between an upstream shaft end and a downstream shaft end.

The separator device preferably comprises a drive unit which is coupled, in particular is coupled mechanically, to the drive shaft in the region of the downstream shaft end in order to drive the drive shaft. The mechanical coupling between the drive shaft and the drive unit is preferably a non-positive and/or positively locking coupling. It can be preferred, in particular, that the drive shaft and the drive unit are coupled to one another in a non-positive manner by way of a screw connection and/or interference fit. In particular, the drive unit is coupled mechanically without a seal to the drive shaft in the region of the downstream shaft end. A drive unit which is mechanically coupled without a seal to the drive shaft in the region of the downstream shaft end has, in particular, no shaft seal and/or slide ring seal. This has the advantage that fewer wear parts are used in this separator device and therefore less maintenance work is required.

The drive unit has a motor shaft which is mounted rotatably about a motor rotational axis. The drive unit is preferably arranged in such a way that the motor rotational axis is inclined with respect to the drive rotational axis. It can be preferred, in particular, that the drive unit is arranged with respect to the drive shaft in such a way that the motor rotational axis extends orthogonally with respect to the drive rotational axis.

It is preferred, in particular, that the drive shaft is coupled mechanically to the drive unit in such a way that the drive shaft is preloaded in the axial direction with a tensile force. The drive shaft is preferably configured as a tension rod to this end. The tension rod can be, for example, of cylindrical configuration with a constant cross section, or the tension rod can have, for example in the region of the upstream shaft end and in the region of the downstream shaft end, in each case a shaft end portion with a cross section, the area extent of which is greater than an area extent of a cross section of a shaft middle portion which extends between the two shaft end portions.

The drive shaft is preferably configured as a solid shaft.

Furthermore, the separator device has a conveying screw. The conveying screw is connected to the drive shaft and is configured to convey the wet mass to be separated from the liquid, that is to say the wet mass to be dewatered, in a conveying direction from an upstream inlet to an outlet which is downstream with respect to the inlet.

The conveying screw is preferably of hollow configuration; in particular, the conveying screw encloses the drive shaft at least partially. The drive shaft particularly preferably extends within the conveying screw.

The conveying screw preferably extends in the axial direction between an upstream screw end and a downstream screw end. The conveying screw, in particular in the region of the upstream screw end, is coupled mechanically in the region of the upstream shaft end to the drive shaft. It is preferred that the conveying screw and the drive shaft are coupled to one another in a non-positive and/or positively locking manner. It is preferred, in particular, that the conveying screw and the drive shaft are coupled to one another in a non-positive manner by way of a screw connection and/or interference fit.

The drive shaft and/or the conveying screw are/is preferably arranged movably or adjustably in the axial direction. In particular, the separator device has a shaft adjusting unit for adjusting the drive shaft and/or the conveying screw in the axial direction. In particular, the drive shaft and/or the conveying screw are/is arranged movably or adjustably in the axial direction with respect to a screen device which is described in the following text.

Furthermore, it is provided that the separator device has a screen device which encloses the conveying screw. The conveying screw preferably extends within the screen device. The screen device is preferably arranged in a stationary manner with respect to the conveying screw.

The screen device is configured to separate the liquid from the wet mass, that is to say to dewater it. Furthermore, the screen device is configured to guide the wet mass, in particular solids of the wet mass, in the conveying direction from the inlet to the outlet. The screen device preferably extends between the inlet and the outlet.

Both the conveying screw and the screen device of the separator device are in each case of conical configuration.

The screen device comprises, in particular, a screen wall made from a curved or rolled metal sheet or curved or rolled steel plate, in which outlet openings have been made as a screen pattern. The outlet openings are made, for example, by means of laser cutting. In particular, the screen wall is a conically rolled and/or conically curved screen wall. In particular, the screen wall has a welded seam which fixes the conically rolled and/or conically curved screen wall in a conical shape.

The separator device preferably has a screen device housing, an inlet chamber, and an outlet chamber.

It is preferred that the screen device is arranged within the screen device housing. It is preferably provided in this preferred embodiment that the screen device housing has the inlet and the outlet, and the screen device is arranged within the screen device housing in such a way that the screen device connects the inlet and the outlet in flow terms. Furthermore, the screen device housing preferably has an outflow opening, through which the separated liquid can be discharged from the screen device housing.

It can be preferred that the separator device has a suction device which is connected in flow terms to the outflow opening. To this end, the suction device is preferably arranged outside the screen device, and is connected in flow terms to the screen device downstream of the inlet. The suction device is configured to separate the liquid from the wet mass. The suction device sucks the liquid through the outlet openings of the liquid-permeable screen wall. For example, the suction device can be connected in flow terms to a liquid tank, into which the liquid is extracted.

Furthermore, it is finally provided in accordance with one preferred development of the separator device that the suction device is configured to suck in the liquid separated from the wet mass and/or the wet mass which is to be provided at the inlet by way of a vacuum. The vacuum is, in particular, a pressure which is lower than atmospheric pressure which prevails, in particular, at the operating location of the separator device. It is provided, in particular, that the suction device extracts the liquid by way of a pressure which is lower than the pressure which prevails at the inlet and/or outlet. In particular, the suction device is configured to generate a vacuum of such a type that the wet mass which is to be provided at the inlet can be provided even from a pit or the like which lies at a substantially lower location than the separator device.

In this regard, a separator device which is configured in this way has the advantage that the wet mass which is provided at the inlet can be sucked in particularly satisfactorily. Furthermore, this development has the advantage that the wet mass can be sucked in even from pits which lie at a lower location than the separator device.

It is provided that the inlet chamber is arranged at the inlet, the inlet chamber being configured to receive the wet mass to be separated from the liquid and to provide it at the inlet. It is provided in addition or as an alternative that the outlet chamber is arranged at the outlet, the outlet chamber being configured to receive the mass which is provided at the outlet and is separated from the liquid. The mass which is provided in the inlet chamber at the inlet has a higher moisture than the mass which is provided in the outlet chamber at the outlet.

It can be preferred, in particular, that the separator device has a molding device which is arranged downstream of the outlet and which encloses the drive shaft. In particular, the molding device is arranged displaceably in the axial direction. The molding device is particularly preferably arranged displaceably in the axial direction with respect to the outlet. In particular, the molding device has a variable internal diameter which can be varied between a minimum internal diameter and a maximum internal diameter which is greater than the minimum internal diameter. The minimum internal diameter preferably corresponds to an external diameter of the conveying screw shaft. The molding device can be varied, in particular, between a closure position, in which the outlet is closed, and an open position, in which the outlet is open. In the closure position, the minimum internal diameter corresponds to the external diameter the minimum internal diameter to an external diameter of the conveying screw shaft and, in the open position, the internal diameter of the molding device is greater than the minimum internal diameter.

The molding device preferably has a ring unit. The ring unit can be configured as an elastic single-part ring, in particular as a single-part rubber ring. Furthermore, it can be preferred that the molding device has a molding device flange, to which the ring unit is fastened. In particular, the molding device flange has a cylindrical molding device flange portion. Furthermore, it can be preferred that the outlet is configured as a flange, it being possible for the outlet which is configured as a flange to have a cylindrical outlet portion. It is preferred, in particular, that the cylindrical molding device flange portion is mounted movably on the cylindrical outlet portion.

A separator device of this type has various advantages. In particular, the conveying screw bears tightly against the screen device regardless of the wear of the conveying screw. Furthermore, the conical configuration makes improved dewatering of wet masses possible in comparison with known solutions.

In accordance with one preferred embodiment of the separator device, the screen device is of hollow-conical configuration. In particular, the screen device of hollow-conical configuration has a conical screen interior space.

In accordance with a further preferred development of the separator device, the screen device has an annular screen cross-sectional area and/or a screen internal diameter and/or a screen external diameter which decrease/decreases from the upstream inlet to the downstream outlet.

Furthermore, it is provided in one preferred development that, in order to separate the liquid from the solids of the mass, the screen device has a conically configured and liquid-permeable screen wall with outlet openings which extend between a screen inner surface of the screen wall which faces the conveying screw and a screen outer surface of the screen wall which lies radially on the outside in relation to the screen inner surface and faces away from the conveying screw, through which outlet openings the liquid which is separated from the wet mass during operation of the separator device can exit.

Furthermore, it is provided in accordance with one preferred embodiment of the separator device that the outlet openings have an opening cross section which increases from the screen inner surface in the direction of the screen outer surface.

It is provided in accordance with a further preferred embodiment of the separator device that the conveying screw has a screw cross-sectional area which decreases from the upstream inlet to the downstream outlet.

Furthermore, it is provided in a further preferred development of the separator device that the conveying screw has a conical screw flight with a screw flight height which varies in the conveying direction or is constant, and/or the conveying screw has a conveying screw shaft with a conveying screw external diameter, the conveying screw external diameter preferably being constant in the conveying direction or varying.

Furthermore, it is provided in a further development of the separator device that the screw flight height decreases from the upstream inlet to the downstream outlet.

Furthermore, it is provided in accordance with one preferred embodiment of the separator device that the screw flight has a screw flight outer radius and a screw flight inner radius, the screw flight inner radius being smaller than the screw flight outer radius. It is provided here that the screw flight outer radius decreases and the screw flight inner radius is constant in the conveying direction, or the screw flight outer radius decreases and the screw flight inner radius decreases in the conveying direction.

It is provided in accordance with a further preferred development of the separator device that the conveying screw, in particular the screw flight, bears tightly against the screen device, in particular the screen inner surface.

It is provided in accordance with a further preferred development of the separator device that the conveying screw is arranged displaceably in the conveying direction with respect to the screen device.

This second aspect is defined by the subject matter of the following embodiments:

A separator device for dewatering a wet mass, the separator device having:
a drive shaft which is mounted rotatably about a drive rotational axis and extends in an axial direction between an upstream shaft end and a downstream shaft end,
a conveying screw which is connected to the drive shaft and is configured to convey the wet mass which is to be separated from the liquid in a conveying direction from an upstream inlet to an outlet which lies downstream with respect to the inlet,
a screen device which encloses the conveying screw, the screen device being configured
   to separate the liquid from the wet mass, and
   to guide the wet mass, in particular solids of the wet mass, in the conveying direction from the inlet to the outlet, and
      characterized in that
the envelope of the conveying screw and the inner surface of the screen device are each of conical configuration.

The separator device as described above, the screen device being of hollow-conical configuration.

The separator device as claimed, the screen device having an annular screen cross-sectional area and/or a screen internal diameter and/or a screen external diameter which decrease/decreases from the upstream inlet to the downstream outlet.

The separator device as described above, the screen device for separating the liquid from the solids of the mass having a conically configured and liquid-permeable screen wall with outlet openings which extend between a screen inner surface of the screen wall which faces the conveying screw and a screen outer surface of the screen wall which lies radially on the outside in relation to the screen inner surface and faces away from the conveying screw, through which outlet openings the liquid which is separated from the wet mass during operation of the separator device can exit.

The separator device (as described above, the outlet openings having an opening cross section which increases from the screen inner surface in the direction of the screen outer surface.

The separator device as described above, the conveying screw having a screw cross-sectional area which decreases from the upstream inlet to the downstream outlet.

The separator device as described above, the conveying screw having a conical screw flight with a screw flight height which varies in the conveying direction or is constant, and/or the conveying screw having a conveying screw shaft with a conveying screw external diameter, the conveying screw external diameter preferably being constant in the conveying direction or varying.

The separator device as described above, the screw flight height decreasing from the upstream inlet to the downstream outlet.

The separator device as claimed, the screw flight having a screw flight outer radius and a screw flight inner radius which is smaller than the screw flight outer radius,
the screw flight outer radius decreasing and the screw flight inner radius being constant in the conveying direction; or
the screw flight outer radius decreasing and the screw flight inner radius decreasing in the conveying direction.

The separator device as described above, the conveying screw, in particular the screw flight, bearing tightly against the screen device, in particular the screen inner surface.

The separator device as described above, the conveying screw being arranged displaceably in the axial direction with respect to the screen device.

### Third Aspect of the Invention: Displaceable Rubber Disk, in Order to Set Content of the Dry Substance of the Mass which is Provided at the Outlet

In accordance with a third aspect, the invention relates to a separator device for dewatering a wet mass.

It is known for a wet mass to be dewatered by way of a separator device. In order to dewater wet masses, separator devices of this type have a cylindrical conveying screw which is enclosed by a screen device and conveys the wet mass from an inlet to an outlet. Furthermore, separator devices of this type have a molding device which is arranged in a stationary manner at the outlet of the separator device and closes the outlet until a certain conveying pressure which is generated by way of the conveying screw is exceeded and the separator device provides the dewatered wet mass at the outlet. The molding device therefore holds back the wet mass to be conveyed in a manner which is dependent on the stiffness of the molding device. Therefore, the degree of residual moisture which the wet mass to be dewatered is to have at the outlet is dependent on the stiffness of the molding device. If the residual moisture of the dewatered mass is to be changed at the outlet, a molding device with a correspondingly changed stiffness is to be provided.

In the case of the known solutions, a desired residual moisture which the wet mass to be dewatered is to have at the outlet therefore cannot be set flexibly and inexpensively by way of the molding device.

It is therefore an object to provide a separator device for dewatering wet masses, which separator device makes simply adjustable and inexpensive dewatering of wet masses possible.

In accordance with this third aspect, this object is achieved by way of a separator device for dewatering a wet mass, the separator device having a drive shaft which is mounted rotatably about a drive rotational axis and extends in an axial direction between an upstream shaft end and a downstream shaft end, a conveying screw which is connected to the drive shaft and is configured to convey the mass in a conveying direction from an upstream inlet to an outlet which is downstream with respect to the inlet, a screen device which encloses the conveying screw, the screen device being configured to separate liquid from the wet mass and to guide the wet mass, in particular solids of the wet mass, in the conveying direction from the inlet to the outlet, and characterized in that a molding device which encloses the conveying screw is arranged displaceably in the axial direction downstream of the outlet.

The molding device is relatively displaceable in the axial direction. This can be realized by way of a displacement of the molding device together with the conveying screw and/or the drive shaft, with the result that a displacement of this entire unit relative to the screen device is provided. The molding device can also be axially displaceable relative to the conveying screw or relative to the drive shaft, with the result that the displacement of the molding device can take place regardless of the position and a displacement of the conveying screw and/or the drive shaft. As a result of the displacement of the molding body, the portion, in which a plug of the mass which is as far as possible dewatered is formed, can be extended in the axial direction, with the result that a longer plug is formed and, as a consequence, a higher back counter-pressure arises at the outlet. As a result, the dewatering in the region of the conveying screw and the screen device is boosted, since the conveying pressure rises. As a consequence, the dewatering rate can be open-loop or closed-loop controlled in this way by way of displacement of the molding body.

The separator device is configured to dewater wet masses. A wet mass is, in particular, a solids-containing suspension. A wet mass comprises, in particular, solids and liquid.

In order to dewater the wet mass, the separator device has a drive shaft which is mounted rotatably about a drive rotational axis. The drive shaft extends in an axial direction between an upstream shaft end and a downstream shaft end.

The separator device preferably comprises a drive unit which, in order to drive the drive shaft, is coupled, in particular is coupled mechanically, to the drive shaft in the region of the downstream shaft end. The mechanical coupling between the drive shaft and the drive unit is preferably a non-positive and/or positively locking coupling. It can be preferred, in particular, that the drive shaft and the drive unit are coupled to one another in a non-positive manner by way of a screw connection and/or interference fit. In particular, the drive unit is mechanically coupled without a seal to the drive shaft in the region of the downstream shaft end. A drive unit which is mechanically coupled without a seal to the drive shaft in the region of the downstream shaft end does not have, in particular, a shaft seal and/or slide ring seal. This has the advantage that fewer wear parts are used in this separator device and less maintenance work is required in this regard.

The drive unit has a motor shaft which is mounted rotatably about a motor rotational axis. The drive unit is preferably arranged in such a way that the motor rotational axis is inclined with respect to the drive rotational axis. It can be preferred, in particular, that the drive unit is arranged with respect to the drive shaft in such a way that the motor rotational axis extends orthogonally with respect to the drive rotational axis.

It is preferred, in particular, that the drive shaft is coupled mechanically to the drive unit in such a way that the drive shaft is preloaded with a tensile force in the axial direction. The drive shaft is preferably configured as a tension rod to this end. The tension rod can be, for example, of cylindrical configuration with a constant cross section, or the tension rod can have, for example in the region of the upstream shaft end and in the region of the downstream shaft end, in each case one shaft end portion with a cross section, the area extent of which is greater than an area extent of a cross section of a shaft middle portion which extends between the two shaft end portions.

The drive shaft is preferably configured as a solid shaft.

Furthermore, the separator device has a conveying screw. The conveying screw is connected to the drive shaft and is configured to convey the wet mass to be separated from the liquid, that is to say the wet mass to be dewatered, in a conveying direction from an upstream inlet to an outlet which is downstream with respect to the inlet. In particular, the conveying screw encloses the drive shaft at least partially. The conveying screw is preferably of conical configuration.

It is preferred, in particular, that the conveying screw has a screw cross-sectional area which decreases from the upstream inlet to the downstream outlet. In particular, the conveying screw has a conical screw flight with a screw flight height which varies in the conveying direction or is constant. The screw flight height preferably decreases from the upstream inlet to the downstream outlet.

It is preferably provided that the screw flight has a screw flight outer radius and a screw flight inner radius which is smaller than the screw flight outer radius, the screw flight outer radius decreasing and the screw flight inner radius being constant in the conveying direction, or the screw flight outer radius decreasing and the screw flight inner radius decreasing in the conveying direction.

Furthermore, it is provided that the separator device has a screen device which encloses the conveying screw. The conveying screw preferably extends within the screen device. The conveying screw, in particular the screw flight, preferably bears tightly against the screen device, in particular the screen inner surface. The conveying screw is preferably arranged rotatably within the screen device. The screen device is preferably arranged in a stationary manner with respect to the conveying screw.

The screen device is configured to separate the liquid from the wet mass, that is to say to dewater it. Furthermore, the screen device is configured to guide the wet mass, in particular solids of the wet mass, in the conveying direction from the inlet to the outlet.

The screen device of the separator device is preferably of conical, in particular hollow-conical, configuration. The screen device comprises, in particular, a screen wall made from a curved or rolled metal sheet or curved or rolled steel plate, in which outlet openings have been made as a screen pattern. The outlet openings are made, for example, by means of laser cutting. In particular, the screen wall is a conically rolled and/or conically curved screen wall. In particular, the screen wall has a welded seam which fixes the conically rolled and/or conically curved screen wall in a conical shape.

It is particularly preferred that the screen device for separating the liquid from the wet mass has a conically configured and liquid-permeable screen wall with outlet openings which extend between a screen inner surface of the screen wall which faces the conveying screw and a screen outer surface of the screen wall which lies radially on the outside in relation to the screen inner surface and faces away from the conveying screw. As a result, the liquid which is separated from the wet mass can exit from the screen device during operation of the separator device.

In particular, the screen device has an annular screen cross-sectional area and/or a screen internal diameter and/or a screen external diameter which decrease/decreases from the upstream inlet to the downstream outlet.

The separator device preferably has a screen device housing, an inlet chamber and an outlet chamber.

It is preferred that the screen device is arranged within the screen device housing. In this preferred embodiment, it is preferably provided that the screen device housing has the inlet and the outlet, and the screen device is arranged within the screen device housing in such a way that the screen device connects the inlet and the outlet in flow terms. Furthermore, the screen device housing preferably has an outflow opening, through which the separated liquid can be discharged from the screen device housing.

It can be preferred that the separator device has a suction device which is connected to the outflow opening in flow terms. To this end, the suction device is preferably arranged outside the screen device, and is connected to the screen device in flow terms downstream of the inlet. The suction device is configured to separate the liquid from the wet mass. The suction device extracts the liquid through the outlet openings of the liquid-permeable screen wall. For example, the suction device can be connected in flow terms to a liquid tank, into which the liquid is extracted.

Furthermore, it is finally provided in accordance with one preferred development of the separator device that the suction device is configured to suck in the liquid which is separated from the wet mass and/or the wet mass which is to be provided at the inlet by way of a vacuum. The vacuum is, in particular, a pressure which is lower than atmospheric pressure which prevails, in particular, at the operating location of the separator device. It is provided, in particular, that the suction device extracts the liquid by way of a pressure which is lower than the pressure which prevails at the inlet and/or outlet. In particular, the suction device is configured to generate a vacuum of such a type that the wet mass which is to be provided at the inlet can be provided even from a pit or the like which lies at a substantially lower location than the separator device.

In this regard, a separator device which is configured in this way has the advantage that the wet mass which is provided at the inlet is sucked in particularly satisfactorily. Furthermore, this development has the advantage that the wet mass can be sucked in even from pits which lie at a lower location than the separator device.

It is preferably provided that the inlet chamber is arranged at the inlet, the inlet chamber being configured to receive the wet mass which is to be separated from the liquid and to provide it at the inlet. In addition or as an alternative, it is provided that the outlet chamber is arranged at the outlet, the outlet chamber being configured to receive the mass which is provided at the outlet and is separated from the liquid. The mass which is provided in the inlet chamber at the inlet has a higher moisture than the mass which is provided in the outlet chamber at the outlet.

Furthermore, the separator device has a molding device which encloses the conveying screw, and is arranged displaceably in the axial direction downstream of the outlet.

A separator device of this type has various advantages. In particular, a movably mounted molding device makes a flexibly and inexpensively adjustable residual moisture of the wet mass to be dewatered at the outlet possible.

It is provided in accordance with one preferred development of the separator device that the molding device has a variable internal diameter which can be varied between a minimum internal diameter and a maximum internal diameter which is greater than the minimum internal diameter.

It is provided in accordance with a further preferred embodiment of the separator device that the minimum internal diameter corresponds to an external diameter of the drive shaft.

Furthermore, it is provided in accordance with one preferred development of the separator device that the molding device can be varied between a closure position, in which the outlet is closed, and an open position, in which the outlet is open, the minimum internal diameter corresponding to the external diameter of the drive shaft in the closure position, and the internal diameter of the molding device being greater than the minimum internal diameter in the open position.

It is provided in accordance with a further preferred embodiment that the molding device has a ring unit.

Furthermore, it is provided in accordance with one preferred development of the separator device that the ring unit is configured as a single-part ring, in particular as a single-part rubber ring. In particular, the ring unit is configured as an elastic single-part ring.

Furthermore, it is provided in accordance with one preferred embodiment of the separator device that the molding device has a molding device flange, to which the ring unit is fastened.

It is provided in accordance with a further preferred development of the separator device that the molding device flange has a cylindrical molding device flange portion.

It is provided in accordance with a further preferred development of the separator device that the outlet is configured as a flange.

Furthermore, it is provided in accordance with one preferred embodiment of the separator device that the outlet which is configured as a flange has a cylindrical outlet portion.

It is provided in accordance with one preferred development of the separator device that the cylindrical molding device flange portion is mounted movably on the cylindrical outlet portion.

This third aspect is defined by the subject matter of the following embodiments:
A separator device for dewatering a wet mass, the separator device having:
   a drive shaft which is mounted rotatably about a drive rotational axis and extends in an axial direction between an upstream shaft end and a downstream shaft end,
   a conveying screw which is connected to the drive shaft and is configured to convey the mass in a conveying direction from an upstream inlet to an outlet which is downstream with respect to the inlet,
   a screen device which encloses the conveying screw, the screen device being configured
   to separate liquid from the wet mass, and
   to guide the wet mass, in particular solids of the wet mass, in the conveying direction from the inlet to the outlet, and
      characterized in that
a molding device which encloses the conveying screw is arranged displaceably in the axial direction downstream of the outlet.

The separator device as described above, the molding device having a variable internal diameter which can be varied between a minimum internal diameter and a maximum internal diameter which is greater than the minimum internal diameter.

The separator device as described above, the minimum internal diameter corresponding to an external diameter of the drive shaft.

The separator device as described above, the molding device being variable between a closure position, in which the outlet is closed, and an open position, in which the outlet is open, the minimum internal diameter corresponding to the external diameter of the drive shaft in the closure position, and the internal diameter of the molding device being greater than the minimum internal diameter in the open position.

The separator device as described above, the molding device having a ring unit.

The separator device as described above, the ring unit being configured as a single-part ring, in particular as a single-part rubber ring.

The separator device as described above, the molding device having a molding device flange, to which the ring unit is fastened.

The separator device as described above, the molding device flange having a cylindrical molding device flange portion.

The separator device as described above, the outlet being configured as a flange.

The separator device as described above, the outlet which is configured as a flange having a cylindrical outlet portion.

The separator device as described above, the cylindrical molding device flange portion being mounted movably on the cylindrical outlet portion.

For further advantages, design variants and design details of the second and third aspect and their possible developments, reference is also made to the above description in respect of the corresponding features and developments of the separator device in accordance with the first aspect and its possible developments.

### BRIEF DESCRIPTION OF THE DRAWINGS

Preferred exemplary embodiments of the first and/or the second and/or the third aspect of the invention will be described by way of example on the basis of the appended figures, in which:

FIG. 1 shows a diagrammatic, three-dimensional view of one exemplary preferred embodiment of a separator device;

FIG. 2 shows a sectional view of one preferred embodiment of the separator device based on the preferred embodiment of a separator device shown in FIG. 1;

FIG. 3 shows a sectional view of a further preferred embodiment of the separator device based on the preferred embodiment of a separator device shown in FIG. 2;

FIG. 4 shows a sectional view of a further preferred embodiment of the separator device based on the preferred embodiment of a separator device shown in FIG. 1;

FIG. 5a shows a sectional view of a further preferred embodiment of the separator device based on the preferred embodiment of a separator device shown in FIG. 1;

FIG. 5b shows a detailed illustration of the sectional view shown in FIG. 5a;

FIG. 6 shows a sectional view of a further preferred embodiment of a separator device based on the preferred embodiment of a separator device shown in FIGS. 5a and 5b; and

FIG. 7 shows a sectional view of a further preferred embodiment of a separator device based on the preferred embodiment of a separator device shown in FIG. 1.

### DETAILED DESCRIPTION OF THE EMBODIMENTS

In the Figures, identical or substantially functionally identical elements are provided with the same designations. General descriptions as a rule relate to all embodiments unless differences are explicitly specified. The explanation of the invention on the basis of examples with reference to the figures takes place substantially diagrammatically, and the elements which are explained in the respective figure can be exaggerated therein for improved illustration and other elements can be simplified.

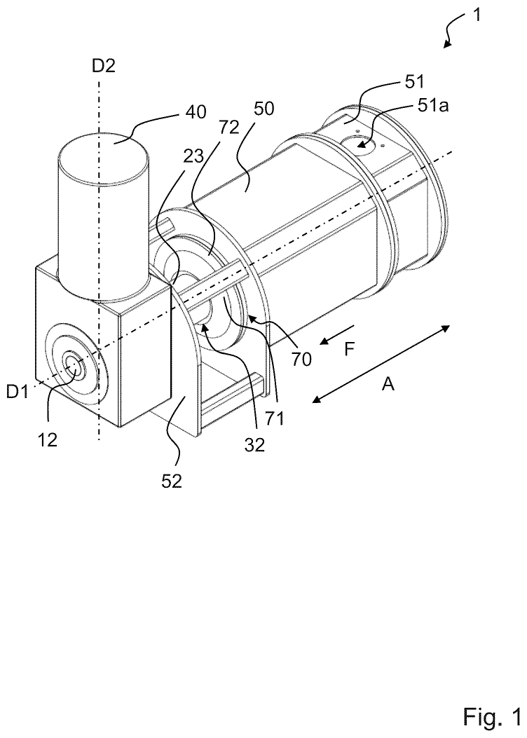

FIG. 1 shows a diagrammatic, three-dimensional view of one exemplary embodiment of a separator device 1. The separator device 1 is configured to dewater a wet mass M, in order to provide a dewatered mass S with a desired dry mass content. To this end, the separator device 1 has a drive shaft 10 which is mounted rotatably about a drive rotational axis D1 and extends in an axial direction A between an upstream shaft end 11 and a downstream shaft end 12. The drive shaft 10 is driven by a motor shaft of a drive unit 40, which motor shaft is mounted rotatably about a motor rotational axis D2. In the present exemplary embodiment, the motor rotational axis D2 extends orthogonally with respect to the drive rotational axis D1; an arrangement of the drive unit 40 which differs from this and in the case of which the motor rotational axis D2 is oriented in an inclined manner with respect to the drive rotational axis D1 or the motor rotational axis D2 extends parallel to the drive rotational axis D1 is conceivable.

In order to convey the wet mass M to be dewatered in a conveying direction F and to separate the liquid L from the mass M to be dewatered, in order to provide a dewatered mass S with a desired dry mass content, a conveying screw 20 is arranged rotatably within a screen device 30, with the result that the screen device 30 encloses the conveying screw 20. In the present exemplary embodiment, the screen device 30 is in turn arranged within a screen device housing 50. The arrangement of the screen device 30 within the screen device housing 50, and also the drive shaft 10, are concealed by way of the screen device housing 50 in the illustration of the separator device 1 in FIG. 1. FIG. 1 visibly shows merely the downstream shaft end 12 of the drive shaft 10 and a portion of the conveying screw shaft of the conveying screw 20.

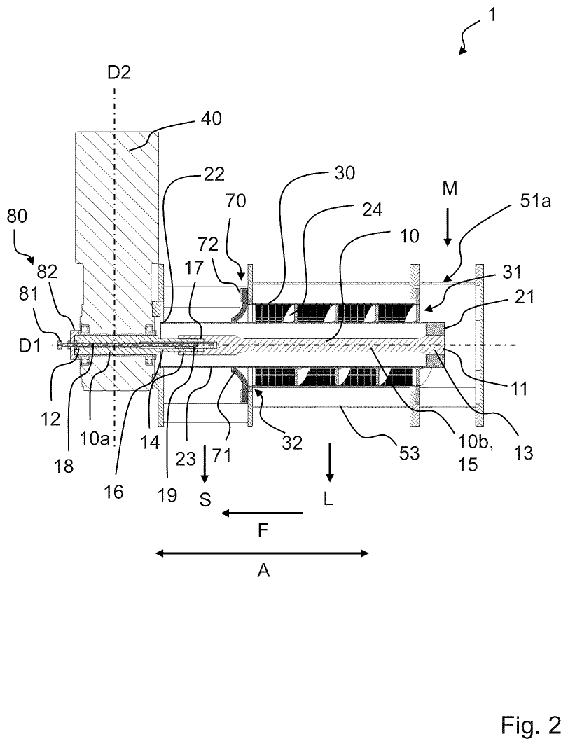

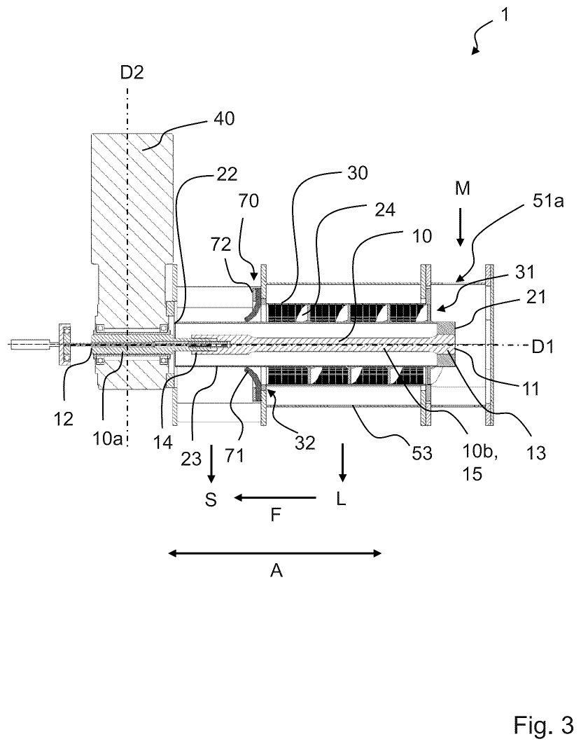

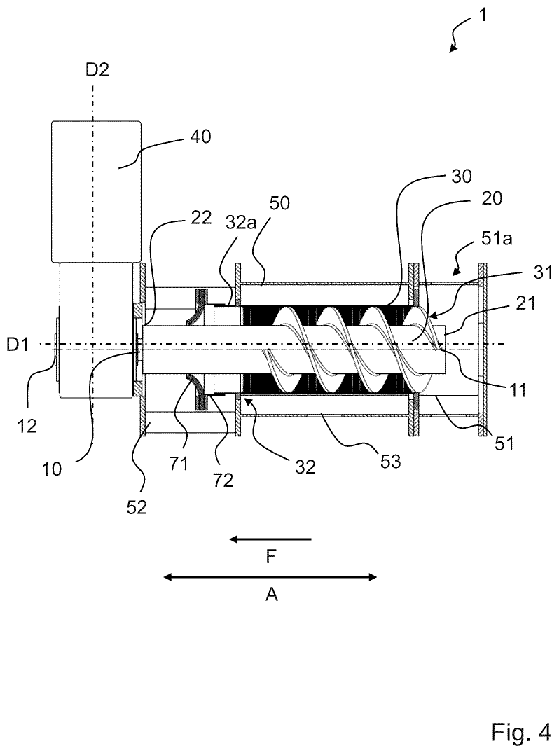

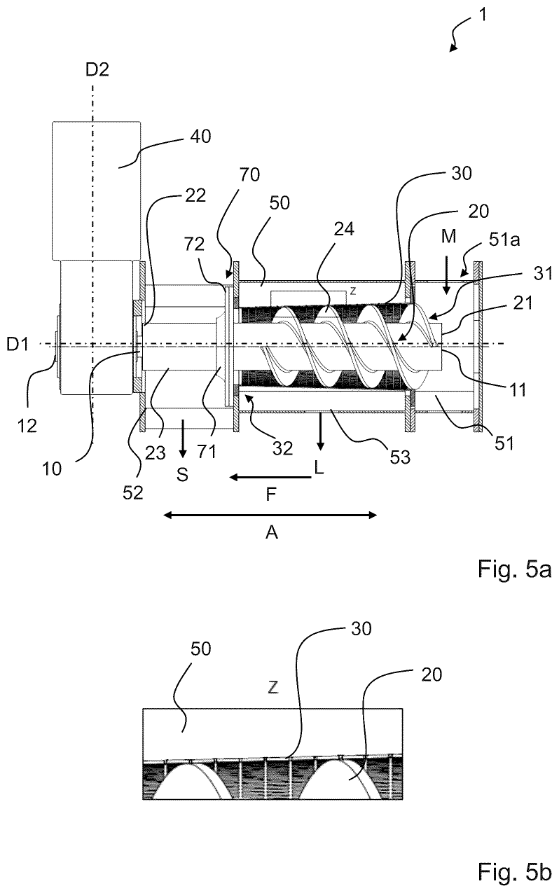

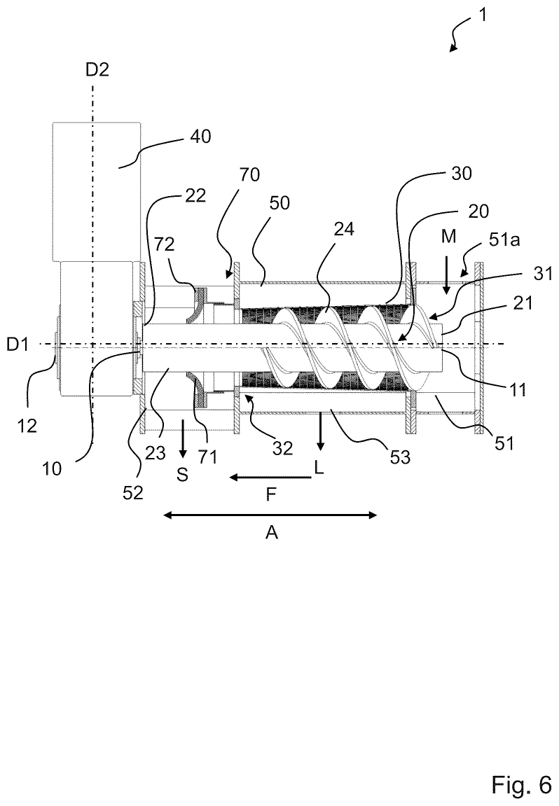

Details with respect to the arrangement of the screen device 30 within the screen device housing 50 can be gathered from the sectional illustrations in FIGS. 2 to 7. FIGS. 3 and 4 show preferred embodiments of the separator device 1 which have a cylindrical screen device 30, within which a cylindrical conveying screw 20 is mounted rotatably. FIGS. 5a, 5b, and 6 show preferred embodiments of the separator device 1 which have a conical screen device 30, within which a conical conveying screw 20 is mounted rotatably.

It becomes clear in the preferred embodiments that the conveying screw 20 and the screen device 30 are configured in such a way that the conveying screw 20 bears tightly against the screen device 30, in particular against a screen inner surface of a liquid-permeable screen wall of the screen device 30. As a result of this arrangement, the wet mass M to be dewatered is compressed in the conveying direction F between the conveying screw 20 and the screen device 30 in a manner which is dependent on a conveying pressure. This brings it about that the liquid L is pressed out of the wet mass M through the liquid-permeable screen wall of the screen device 30.

The liquid-permeable screen wall has outlet openings which extend between the screen inner surface of the screen wall which faces the conveying screw 20 and a screen outer surface of the screen wall which lies radially on the outside in relation to the screen inner surface and faces away from the conveying screw 20. The liquid L which is separated from the wet mass M can exit from the screen device 30 through the outlet openings. Here, the size of the outlet openings is configured in such a way that the liquid L but not the solids of the wet mass M can exit from the screen device through the screen wall, with the result that the solids of the wet mass M are guided by way of the screen device 30 as far as the outlet 32. The outlet openings preferably have a cross section which increases from the screen inner surface in the direction of the screen outer surface.

The screen device housing 50 has an inlet 31 and an outlet 32 which are connected in flow terms by the screen device 30. An inlet chamber 51 is arranged at the inlet 31 of the screen device housing 50, and an outlet chamber 52 is arranged at the outlet 32 of the screen device housing 50. The screen device housing 50 therefore extends in the axial direction between the inlet chamber and the outlet chamber. The inlet chamber and the outlet chamber are therefore connected to one another in flow terms by way of the screen device housing 50. The inlet chamber 51 is configured to receive the wet mass M to be dewatered and to provide it at the inlet 31. To this end, the inlet chamber 51 which is shown in FIG. 1 has an opening 51a, through which the wet mass M to be dewatered can be fed to the inlet chamber 51. The wet mass M which is fed to the inlet chamber 51 is conveyed by way of the conveying screw in the conveying direction F from the upstream inlet 31 to the outlet 32 which is downstream with respect to the inlet 31. To this end, the conveying screw 20 is connected to the drive shaft 10, with the result that the rotational movement of the drive shaft 10 is transmitted to the conveying screw 20. When the wet mass which is conveyed by the conveying screw 20 then reaches the outlet 32 as dewatered wet mass S with a desired dry mass content, the dewatered mass S is conveyed into the outlet chamber 52 which is configured to receive the dewatered mass S which is provided at the outlet 32. It is to be understood that the dewatered mass S can have a residual moisture. However, the dry mass content of the dewatered mass S which is provided at the outlet is at any rate greater than the dry mass content of the wet mass M which is to be dewatered and is provided at the inlet.

A molding device 70 which encloses a conveying screw shaft 23 is arranged at the outlet 32 of the separator device 1 which is shown in FIG. 1. In the present exemplary embodiment, the molding device 70 is arranged in the axial direction A downstream of the outlet 32. The molding device 70 is of flexible configuration or elastic configuration, and has a variable internal diameter which can be varied between a minimum internal diameter and a maximum internal diameter which is greater than the minimum internal diameter. In the present illustration, the minimum internal diameter corresponds to an external diameter of the conveying screw shaft 23.

The molding device 70 comprises a ring unit 71 and a molding device flange 72, to which the ring unit 71 is fastened. In the present case, the ring unit 71 is configured as a single-part rubber ring. The rubber ring is arranged with the molding device flange 72 on the screen device housing 50 in the region of the outlet.

The molding device 70 can be varied between a closure position, in which the outlet 32 is closed, and an open position, in which the outlet 32 is open. In the closure position, the screen device housing 50 is closed with respect to the outlet chamber 52, that is to say is not connected in flow terms to the outlet chamber 52. In the open position, the screen device housing 50 is open with respect to the outlet chamber 52, that is to say is connected in flow terms to the outlet chamber 52. In the closure position, the minimum internal diameter corresponds to the external diameter of the conveying screw shaft 23. When the separator device 1 is operated, dewatered mass S enters through the outlet 32 from the screen device housing 50 or the screen device 30 into the outlet chamber 52. Here, the dewatered mass S presses the molding device 70, in particular the ring unit, outward as soon as a certain conveying pressure is reached. The molding device 70 is then situated in the open position, in which the internal diameter of the molding device 70 is greater than its minimum internal diameter and the screen device is connected in flow terms at the outlet to the outlet chamber.

The molding device 70 serves as a resilient resistance and helps to build up a required conveying pressure in the mass M to be conveyed between the conveying screw 20 and the screen device 30, in order to dewater the provided wet mass M in the conveying direction F.

FIGS. 2 and 3 each show a sectional view of one preferred embodiment of the separator device 1 based on the preferred embodiment of the separator device 1 shown in FIG. 1.

In the embodiment shown in FIG. 2, the drive shaft 10 is configured as a solid shaft in the form of a tension rod, and the cylindrical conveying screw shaft 23 of the conveying screw 20 is of hollow configuration. The conveying screw 20 extends in the axial direction A between an upstream screw end 21 and a downstream screw end 22. It becomes clear from the sectional view how the cylindrical screen device 30 encloses the conveying screw 20 and how the conveying screw 20 in turn encloses the drive shaft 10. The conveying screw 20 is mounted rotatably within the screen device 30, and the conveying screw 20 or the conveying screw shaft 23 is coupled mechanically in the region of the upstream screw end 21 to the drive shaft 10 in the region of the upstream shaft end 11. In the embodiment of the separator device 1 shown in FIG. 2, the drive shaft 10 and the conveying screw 20 are mechanically coupled in a non-positive manner by means of an interference fit. As a result of this mechanical connection, the rotational movement of the drive shaft 10 is transmitted to the conveying screw 20. In order to drive the drive shaft 10, the drive shaft 10 is mechanically coupled in the region of the downstream shaft end 12 to the drive unit 40 (not shown in detail).

It can be seen that the drive shaft 10 is configured in multiple parts. The drive shaft 10 has a first sub-shaft 10a and a second sub-shaft 10b. It is provided that the first sub-shaft 10a is mounted rotatably and drivably in the drive unit 40. It is provided, furthermore, that the second sub-shaft 10b is coupled to the conveying screw 20. The first sub-shaft 10 a and the second sub-shaft 10b are coupled to one another within the outlet chamber 52 in a manner which is fixed in terms of torque and transmits an axial force. A screw and plug-in connection is provided to couple the first and the second sub-shaft 10a, 10b in a manner which is fixed in terms of torque and transmits an axial force. To this end, the first sub-shaft 10a has at least one shaft shoulder 16 which is introduced into the second sub-shaft 10b. The second sub-shaft 10b has a corresponding receiving portion 17 for the shaft shoulder 16 of the first sub-shaft 10a. As a result, the first sub-shaft 10a can be plugged into the second sub-shaft 10b, in particular for the transmission of torque. It is particularly preferred that the first and second sub-shaft 10a, 10b are arranged displaceably with respect to one another in the axial direction. It is provided, furthermore, that the first sub-shaft 10a has a through bore 18, and an internally threaded bore 19 is configured on the second sub-shaft 10b.

A shaft adjusting unit 80 is provided in order to adjust the relative position of the second sub-shaft 10b with respect to the first sub-shaft 10a in the axial direction. In the present preferred embodiment, the shaft adjusting unit 80 has a threaded rod 81 which extends through the through bore 18 and is screwed into the internally threaded bore 19. An axial bearing 82 of the shaft adjusting unit 80 is arranged on the end side at the downstream shaft end 12, in which the shaft adjusting unit 80 and the threaded rod 81 are arranged rotatably, and fixedly in the axial direction. If the threaded rod 81 is then rotated, this brings it about that the second sub-shaft 10b is displaced in the axial direction A with respect to the first sub-shaft 10a. As a result, the spacing between the screw flight 24 and the molding device 70 which is arranged at the outlet 32, and therefore the dry mass content of the dewatered mass S which is provided at the outlet, can be set. If the second sub-shaft 10a and therefore the conveying screw 20 is pushed in the axial direction in the direction of the inlet chamber 51, the spacing between the screw flight 24 and the molding device 70 is increased. As a result, the dry mass content of the dewatered mass S which is provided at the outlet 32 increases. If the spacing between the screw flight 24 and the molding device 70 is decreased, that is to say if the second sub-shaft 10b is displaced with the conveying screw 20 in the axial direction in the direction of the outlet chamber 51, the conveying pressure within the screen device drops, and the dry mass content of the dewatered mass S which is provided at the outlet 32 decreases. In the preferred embodiment which is shown in the present case, the conveying screw or the second sub-shaft can be displaced in the axial direction A by way of manual rotation of the threaded bolt or the screw.

In order to realize a drive shaft 10 which is as flexurally slack as possible and compensates for angular errors, the drive shaft 10 (in the present case, the second sub-shaft 10b) has different cross-sectional areas. For instance, the drive shaft 10 which is configured as a tension rod comprises, in the region of the upstream shaft end 11 and in the coupling region of the first and second sub-shaft 10a, 10b, in each case one shaft end portion 13, 14, between which a shaft middle portion 15 extends. Here, the area extent of the cross section of the shaft end portions 13, 14 is greater than the area extent of the cross section of the shaft middle portion 15.

The sectional view of a further preferred embodiment of the separator device 1 which is shown in FIG. 3 is based on the preferred embodiment of a separator device 1 which is shown in FIG. 2. The embodiment of the separator device 1 which is shown in FIG. 3 differs substantially from the preferred embodiment of the separator device 1 which is shown in FIG. 2 in that the shaft adjusting unit 80 can be actuated automatically by way of a drive, in order to bring about an axial displacement of the conveying screw 20 within the screen device 30. To this end, the axial bearing 82 of the shaft adjusting unit 80 has a corresponding connector for a drive and a correspondingly mounted axial bearing of the shaft adjusting unit 80.

FIG. 4 shows a diagrammatic sectional view of a further preferred embodiment of a separator device 1 based on the preferred embodiments of a separator device 1 shown in FIGS. 1 to 3. In contrast to the embodiments of a separator device 1 shown in FIGS. 2 and 3, the conveying screw 20 or the drive shaft 10 of the embodiment of the separator device 1 shown in FIG. 4 cannot be displaced in the axial direction with respect to the screen device 30. Correspondingly, the separator device 1 shown in FIG. 4 has no shaft adjusting unit 80 either.

It is provided in the separator device 1 shown in FIG. 4, however, that the molding device 70 which is arranged downstream of the outlet 32 is arranged displaceably in the axial direction A and encloses the conveying screw shaft 23. It is also the case in this preferred embodiment that the molding device 70 has a variable internal diameter which can be varied between a minimum internal diameter and a maximum internal diameter which is greater than the minimum internal diameter. In the present illustration, the minimum internal diameter corresponds to an external diameter of the conveying screw shaft 23.

It is also the case in this embodiment that the molding device 70 can be varied between a closure position, in which the outlet 32 is closed, and an open position, in which the outlet 32 is open. FIG. 4 shows the molding device 70 in a closure position. In the closure position, the minimum internal diameter corresponds to the external diameter of the conveying screw shaft 23. When the separator device 1 is operated and dry mass S from the outlet 32 enters into the outlet chamber 52, the mass M presses the molding device 70 outward. The molding device 70 is then situated in the open position, in which the internal diameter of the molding device 70 is greater than its minimum internal diameter.

In the preferred embodiment shown in FIG. 4, the molding device 70 has a ring unit 71 and a molding device flange 72, to which the ring unit 71 is fastened. The ring unit 71 is configured as a single-part rubber ring. The molding device flange 72 has a cylindrical molding device flange portion. In the present embodiment, the outlet is configured as a flange 32a which has a cylindrical outlet portion. The molding device 70 is arranged with respect to the outlet 32 in such a way that the cylindrical molding device flange portion encloses the cylindrical outlet portion, with the result that the molding device 70 is movable or displaceable in the axial direction A with respect to the outlet 32. A molding device adjusting unit (not shown) can be provided for displacing the molding device 70, which molding device adjusting unit is configured to displace the molding device 70 in the axial direction with respect to the outlet. If the molding device 70 is displaced in the direction of the drive unit 40, with the result that the spacing between the outlet 32 and the ring unit increases, the dry mass content of the dewatered mass S which is provided at the outlet 32 increases. Conversely, the dry mass content of the dewatered mass S which is provided at the outlet 32 decreases, that is to say the water content increases when the spacing between the outlet 32 and the ring unit of the molding device 70 is decreased.

The preferred embodiment of a separator device 1 shown in FIG. 5a is based substantially on the preferred embodiments of a separator device 1 shown in FIGS. 1 and 2. In contrast to the preferred embodiment of a separator device 1 shown in FIG. 2, the screen device 30 in the case of the sectional view which is shown in FIG. 5a is configured conically as a hollow cone. Here, the hollow cone comprises an annular screen cross-sectional area which changes in the axial direction, a screen internal diameter which changes in the axial direction A, and a screen external diameter which changes in the axial direction A. The annular screen cross-sectional area, the screen internal diameter and the screen external diameter of the screen device 30 decrease in the conveying direction F from the upstream inlet 31 to the downstream outlet 32.

Just like the screen device 30, the conveying screw 20 is also of conical configuration. The conveying screw 20 has a screw cross-sectional area which decreases in the conveying direction F from the upstream inlet 31 to the downstream outlet 32. In the present embodiment, the conveying screw comprises a conically running screw flight 24 with a screw height. The screw height decreases in the conveying direction F. To this end, the conical screw flight 24 has a constant screw flight inner radius in the conveying direction F and a decreasing screw flight outer radius. The screw flight inner radius corresponds to the outer radius or the external diameter of the conveying screw shaft 23. The detailed illustration in FIG. 5b illustrates the conical profile of the screen device 30 and of the conical conveying screw 20 arranged therein.

The preferred embodiment of the separator device 1 shown in FIG. 6 is based on the preferred embodiment of a separator device 1 shown in FIGS. 5a and 5b. In contrast to the preferred embodiment of a separator device 1 shown in FIGS. 5a and 5b, the embodiment of the separator device 1 shown in FIG. 6 has a molding device 70 which is displaceable in the axial direction A with respect to the outlet 32, as is described above in relation to the preferred embodiment of a separator device 1 shown in FIG. 4.

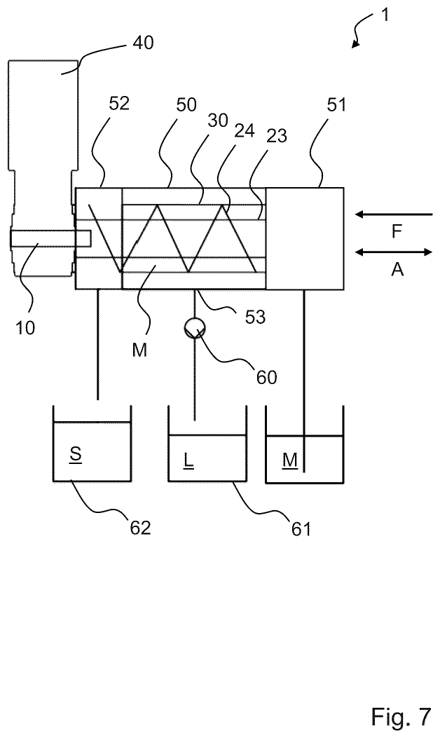

FIG. 7 shows a diagrammatic sectional view of a further preferred embodiment of a separator device 1 based on the preferred embodiment of a separator device 1 shown in FIG. 1. The separator device 1 shown in FIG. 7 has a suction device 60 which is arranged outside the screen device 30 and is connected in flow terms downstream of the inlet 31 to the screen device 30. To this end, the screen device housing 50 preferably has an outflow opening 53, to which the suction device 60 is connected in flow terms in order to extract the liquid L. The suction device 60 is configured to separate the liquid L from the wet mass M to be dewatered, and to extract the liquid L, in particular also through the outlet openings of the liquid-permeable screen wall. To this end, the suction device 60 generates a suction pressure, by way of which the liquid is separated from the mass to be dewatered. Furthermore, the suction pressure of the suction device 60 can be used in a preferred way to suck in the wet mass M to be dewatered which is provided at the inlet. For example, the separator device 1 can also have a liquid tank 61 which is connected in flow terms to the suction device 60 and which receives the liquid L which is extracted by the suction device 60. Accordingly, a solids tank 62 can also be provided which receives the dewatered mass S which is conveyed into the outlet chamber 52. In particular, the suction pressure which is generated by way of the suction device 60 can be set in a manner which is dependent on the desired dry mass content of the dewatered mass S to be provided at the outlet and/or the viscosity of the wet mass M to be dewatered which is provided at the inlet and/or the liquid of the wet mass M to be dewatered which is provided at the inlet.

It can be preferred that the preferred embodiments of a separator device 1 shown above in FIGS. 1 to 6 comprise the suction device which is described in relation to the preferred embodiment of a separator device 1 shown in FIG. 7.

1-14. (canceled)

15. A separator device for dewatering a wet mass to be dewatered, the separator device comprising:
drive shaft mounted rotatably about a drive rotational axis and extending in an axial direction between an upstream shaft end and a downstream shaft end;
a conveying screw connected to the drive shaft and adapted to convey the mass to be dewatered in a conveying direction from an upstream inlet to an outlet which lies downstream with respect to the inlet;
a screen device enclosing the conveying screw, the screen device being adapted to:
separate the liquid from the wet mass to be dewatered, and
guide the wet mass to be dewatered in the conveying direction from the inlet to the outlet; and
a drive unit coupled to the downstream shaft end of the drive shaft and adapted to drive the drive shaft;
wherein the drive shaft is coupled to the drive unit such that the drive shaft is configured as a tension rod.

16. The separator device as claimed in claim 15, wherein the drive shaft is configured as a solid shaft and/or the conveying screw is configured as a hollow configuration.

17. The separator device as claimed in claim 15, wherein the drive shaft has a first flexural configuration and the conveying screw has a second flexural configuration, and the second flexural configuration of the conveying screw is stiffer in comparison with the first flexural configuration of the drive shaft.

18. The separator device as claimed in claim 15, wherein the drive shaft is configured in multiple parts.

19. The separator device as claimed in claim 18, wherein the drive shaft further comprises at least one universal joint and/or a cardan shaft.

20. The separator device as claimed in claim 15, wherein the conveying screw extends in the axial direction between an upstream screw end and a downstream screw end, and the conveying screw in the region of the upstream screw end is coupled mechanically in the region of the upstream shaft end to the drive shaft.

21. The separator device as claimed in claim 20, wherein the conveying screw and the drive shaft are coupled to one another in a non-positive locking manner.

22. The separator device as claimed in claim 20, wherein the conveying screw and the drive shaft are coupled to one another in a positively locking manner.

23. The separator device as claimed in claim 20, wherein the conveying screw and the drive shaft are coupled to one another in a manner which is fixed in terms of torque and/or transmits an axial force.

24. The separator device as claimed in claim 15, wherein the drive shaft is further configured as:
a tension rod which, in the region of the upstream shaft end and in the region of the downstream shaft end, in each case has a shaft end portion with a cross section, the area extent of which is greater than an area extent of a cross section of a shaft middle portion which extends between the two shaft end portions.

25. The separator device as claimed in claim 15, wherein the drive shaft in the region of the downstream shaft end and the drive unit are coupled to one another in a non-positive and/or positively locking manner.

26. The separator device as claimed in claim 25, wherein the drive shaft and the drive unit are coupled to one another in a manner which is fixed in terms of torque and/or transmits an axial force.

27. The separator device as claimed in claim 15, wherein the drive unit comprising a motor shaft mounted rotatably about a motor rotational axis, and the drive unit is arranged such that the motor rotational axis is inclined with respect to the drive rotational axis.

28. The separator device as claimed in claim 15, wherein the drive unit is arranged with respect to the drive shaft such that the motor rotational axis extends orthogonally with respect to the drive rotational axis.

29. The separator device as claimed in claim 15, wherein the outlet is arranged between the drive unit and the screen device.

30. The separator device as claimed in claim 15, wherein the drive shaft and/or the conveying screw is/are arranged displaceably in the axial direction with respect to the screen device.

31. A separator device for dewatering a wet mass, the separator device comprising:
a drive shaft mounted rotatably about a drive rotational axis and extending in an axial direction between an upstream shaft end and a downstream shaft end;
a conveying screw connected to the drive shaft and configured to convey the wet mass which is to be separated from a liquid contained therein in a conveying direction from an upstream inlet to an outlet which lies downstream with respect to the inlet; and
a screen device enclosing the conveying screw, the screen device being configured to:
separate the liquid from the wet mass, and
guide the wet mass, in particular solids of the wet mass, in the conveying direction from the inlet to the outlet;
wherein an envelope of the conveying screw and the inner surface of the screen device are each of conical configuration.

32. The separator device as claimed in claim 31, wherein the screen device is of a hollow-conical configuration.

33. A separator device for dewatering a wet mass, the separator device comprising:
a drive shaft mounted rotatably about a drive rotational axis and extending in an axial direction between an upstream shaft end and a downstream shaft end;
a conveying screw connected to the drive shaft and configured to convey the wet mass in a conveying direction from an upstream inlet to an outlet which is downstream with respect to the inlet; and
a screen device enclosing the conveying screw, the screen device being configured to:
separate liquid from the wet mass, and
guide the wet mass in the conveying direction from the inlet to the outlet;
wherein a molding device that encloses the conveying screw is arranged displaceably in the axial direction downstream of the outlet.

34. The separator device as claimed in claim 33, wherein the molding device has a variable internal diameter that can be varied between a minimum internal diameter and a maximum internal diameter which is greater than the minimum internal diameter.
